(19) United States
(12) Patent Application Publication
(10) Pub. No.: US 2015/0288562 A1
(43) Pub. Date: Oct. 8, 2015

(54) METHOD AND NETWORK NODE FOR CELL CONFIGURATION OF LOWER POWER NODE

(71) Applicant: TELEFONAKTIEBOLAGET L M ERICSSON (PUBL), Stockholm (SE)

(72) Inventor: Sairamesh Nammi, Kista (SE)

(21) Appl. No.: 14/441,865

(22) PCT Filed: Nov. 7, 2013
(86) PCT No.: PCT/SE2013/051316

§ 371 Date: May 11, 2015

Related U.S. Application Data
(60) Provisional application No. 61/725,068, filed on Nov. 12, 2012.

(51) Int. Cl. H04L 12/24; H04W 28/08; H04W 24/02; H04W 16/32

(52) U.S. Cl. CPC H04L 41/0803; H04W 16/32; H04W 28/08; H04W 24/02; H04W 88/12

(57) ABSTRACT

Embodiments herein relate to a method in a network node for configuring a low power node in a wireless communications network, which wireless communications network comprises the low power node and a macro radio node. The low power node has a coverage area that is partially or completely overlapped by a coverage area of a cell of the macro radio node. The network node determines a load of the cell of the macro radio node, and compares the load with a threshold value. The network node configures the low power node for a co channel deployment when the load is greater than or equal to the threshold value; and for a soft cell deployment when the load is not greater than or equal to the threshold value.

### TECHNICAL FIELD

Embodiments herein relate to a network node and a method therein. In particular, embodiments herein relate for configuring a low power node in a wireless communications network. Embodiments herein further disclose a computer program product and a computer-readable storage medium.

### BACKGROUND

In a typical radio communications network or wireless communications network, wireless terminals, also known as mobile stations and/or user equipments (UE), communicate via a Radio Access Network (RAN) to one or more core networks. The radio access network covers a geographical area which is divided into cell areas, with each cell area being served by a base station, e.g., a radio base station (RBS), which in some networks may also be called, for example, a “NodeB” or “eNodeB”. A cell is a geographical area where radio coverage is provided by the radio base station at a base station site or an antenna site in case the antenna and the radio base station are not collocated. Each cell is identified by an identity within the local radio area, which is broadcast in the cell. Another identity identifying the cell uniquely in the whole mobile network is also broadcasted in the cell. One base station may have one or more cells. A cell may be downlink and/or uplink cell. The base stations communicate over the air interface operating on radio frequencies with the user equipments within range of the base stations.

A Universal Mobile Telecommunications System (UMTS) is a third generation mobile communication system, which evolved from the second generation (2G) Global System for Mobile Communications (GSM). The UMTS terrestrial radio access network (UTRAN) is essentially a RAN using wideband code division multiple access (WCDMA) and/or High Speed Packet Access (HSPA) for user equipments. In a forum known as the Third Generation Partnership Project (3GPP), telecommunications suppliers propose and agree upon standards for third generation networks and UTRAN specifically, and investigate enhanced data rate and radio capacity. In some versions of the RAN as e.g. in UMTS, several base stations may be connected, e.g., by landlines or microwave, to a controller node, such as a radio network controller (RNC) or a base station controller (BSC), which supervises and coordinates various activities of the plural base stations connected thereto. The RNCs are typically connected to one or more core networks.

Specifications for the Evolved Packet System (EPS) have been completed within the 3^{rd} Generation Partnership Project (3GPP) and this work continues in the coming 3GPP releases. The EPS comprises the Evolved Universal Terrestrial Radio Access Network (E-UTRAN), also known as the Long Term Evolution (LTE) radio access, and the Evolved Packet Core (EPC), also known as System Architecture Evolution (SAE) core network. E-UTRAN/LTE is a variant of a 3GPP radio access technology wherein the radio base station nodes are directly connected to the EPC core network rather than to RNCs. In general, in E-UTRAN/LTE the functions of a RNC are distributed between the radio base stations nodes, e.g. eNodeBs in LTE, and the core network. As such, the Radio Access Network (RAN) of an EPS has an essentially “flat” architecture comprising radio base station nodes without reporting to RNCs.

During the past few years, wireless operators have offered mobile broadband services based on WCDMA/HSPA. Also, fuelled by new devices designed for data applications, end user performance requirements have increased. The large uptake of mobile broadband has resulted in heavy traffic volumes that need to be handled by the HSPA networks have grown significantly. Therefore, techniques that allow operators to manage their spectrum resources more efficiently are of great importance.

It is possible to improve the downlink performance by introducing support for techniques such as 4-branch Multiple Input Multiple Output (MIMO), multiflow communication, multi carrier deployment, etc. Improvements in spectral efficiency per link are approaching theoretical limits. As a result, the next generation technology tends to focus on improving the spectral efficiency per unit area. Additional features for High Speed Downlink Packet Access (HSDPA) should then provide a uniform user experience to users anywhere inside a cell by changing the topology of traditional networks. Currently 3GPP has been working on this aspect using heterogeneous networks [1]-[3].

Homogeneous Networks:

A homogeneous network is a network of base stations, e.g., NodeBs, in a planned layout and a collection of user terminals in which all base stations have similar transmit power levels, antenna patterns, receiver noise floors, and similar backhaul connectivity to the data network. Moreover, all base stations offer unrestricted access to user terminals in the network, and serve roughly the same number of user terminals. Current wireless systems that come under this category include GSM, WCDMA, HSDPA, LTE, and WiMax.

Heterogeneous Networks:

In a heterogeneous network, in addition to the planned or regular placement of macro base stations, several pico/femto/relay base stations are deployed as illustrated in FIG. 1. The power transmitted by these pico/femto/relay base stations (up to 2 W) is relatively small compared to that of the macro base stations (up to 40 V. These low power nodes (LPN) are typically deployed to eliminate coverage holes in the homogeneous network (using macro base stations only). The LPNs can improve capacity in hot-spots. Due to their low transmit power and small physical size, the pico/femto/relay base stations can offer flexible site acquisitions.

Heterogeneous networks can be divided into two deployment categories—co-channel deployment and soft cell (or combined cell). In the co-channel deployment, a LPN has a cell identifier different from that the macro node. In the soft cell deployment, the LPN has a cell identifier same as that of the macro node.

When the LPNs are configured with different cell identifiers, the network capacity may be improved through load balancing. For example, the macro node may transfer a UE close to a LPN to be connected to that LPN, thereby increase the frequency of serving the UE's. However, the different cell identifier configurations require higher order signaling for handovers, transfers, etc, which can cause problems such as extra delays and UL-DL Imbalance.

When the LPNs are configured with same cell identifiers, a specific UE can benefit since all nodes transmit the data to the specific UE at the same time which increases the individual user throughput. However, the network capacity may not be improved since all the nodes transmit data to the same UE at any time.

### SUMMARY

An object of embodiments herein is to provide a mechanism that improves the performance of the wireless communications network.

According to an aspect the object is achieved by providing a method in a network node for configuring a low power node in a wireless communications network. The wireless communications network comprises the low power node and a macro radio node. The low power node has a coverage area that is partially or completely overlapped by a coverage area of a cell of the macro radio node. The network node determines a load of the cell of the macro radio node. The network node further compares the load with a threshold value. The network node also configures the low power node for a co-channel deployment when the load is greater than or equal to the threshold value; and configures the low power node for a soft cell deployment when the load is not greater than or equal to the threshold value.

According to another aspect the object is achieved by providing a network node for configuring a low power node in a wireless communications network. The wireless communications network comprises the low power node and a macro radio node. The low power node has a coverage area that is partially or completely overlapped by a coverage area of a cell of the macro radio node. The network node is configured to determine a load of the cell of the macro radio node, and to compare the load with a threshold value. The network node further being configured to configure the low power node for a co-channel deployment when the load is greater than or equal to the threshold value; and to configure the low power node for a soft cell deployment when the load is not greater than or equal to the threshold value.

Embodiments herein further disclose a computer program product comprising instructions, which, when executed on at least one processor in a network node, cause the at least one processor to carry out the methods disclosed herein. In addition, a computer-readable storage medium comprising such a computer program product stored thereon, is also disclosed.

Embodiments herein provide gains in the wireless communication network both when load is high in that using co-channel deployment enabling load balancing, and when load is low using soft cell deployment enabling beamforming. E.g. energy from the LPNs may be used efficiently for beamforming when the load is relatively small in a cell.

### BRIEF DESCRIPTION OF THE DRAWINGS

Embodiments will now be described in more detail in relation to the enclosed drawings, in which:

FIG. 1 shows a typical deployment of low power nodes in a heterogeneous network.

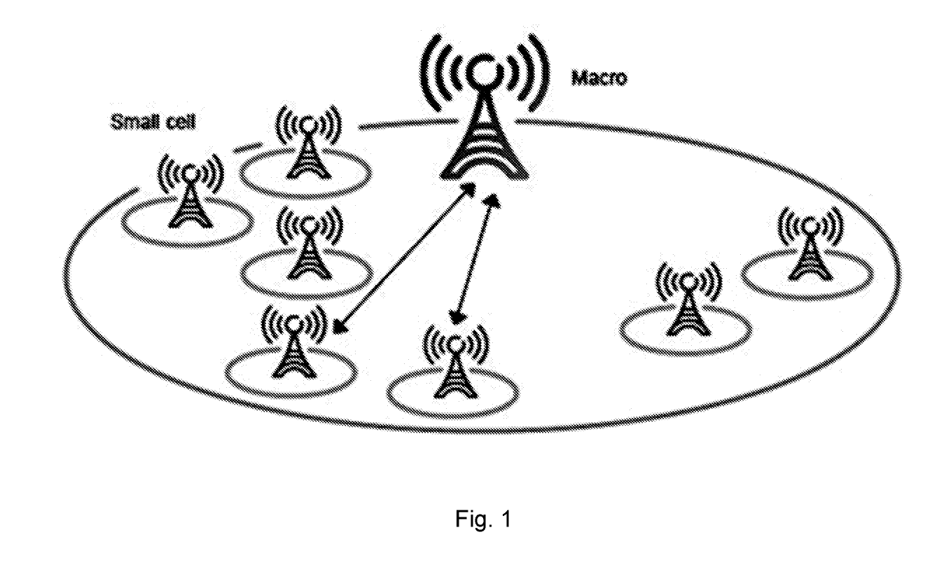

FIG. 2 shows low power nodes with different cell ids (co-channel deployment example).

FIG. 3: shows downlink user throughput in a homogeneous network.

FIG. 4: shows downlink user throughput in a heterogeneous network with co-channel deployment.

FIG. 5: shows low power nodes with same cell ids as the macro radio node (soft cell deployment example).

FIG. 6: shows downlink user throughput in a heterogeneous network with soft cell deployment.

FIG. 7 is a schematic overview depicting a wireless communications network according to embodiments herein.

FIG. 8 is an example of a flow chart of a method to adaptively configure a LPN of a heterogeneous network.

FIG. 9: is an example of adaptively configuring LPN by a network node.

FIG. 10: is a block diagram depicting a network node.

FIG. 11: is a block diagram depicting a network node.

FIG. 12 is a flowchart depicting a method according to embodiments herein.

FIG. 13: is a block diagram depicting a network node according to embodiments herein.

### DETAILED DESCRIPTION

To address one or more of the above mentioned and other problems, one or more methods, apparatuses and/or systems are described herein in which one or more novel configuration techniques may be implemented.

The subject matter described herein generally relates to wireless communication networks. In particular, the subject matter relates to methods, apparatuses, and/or systems for configuring low power nodes in heterogeneous networks. Terminologies from 3GPP are used below only to facilitate explanation and example application. Wireless systems such as WCDMA, WiMax, UMB, GSM, WiFi, and others may benefit from the technology described herein.

As part of developing embodiments herein a problem where first identified. As mentioned above, heterogeneous networks maybe divided into two deployment categories—co-channel deployment and combined cell, or soft cell, deployment.

### Co-Channel Deployment

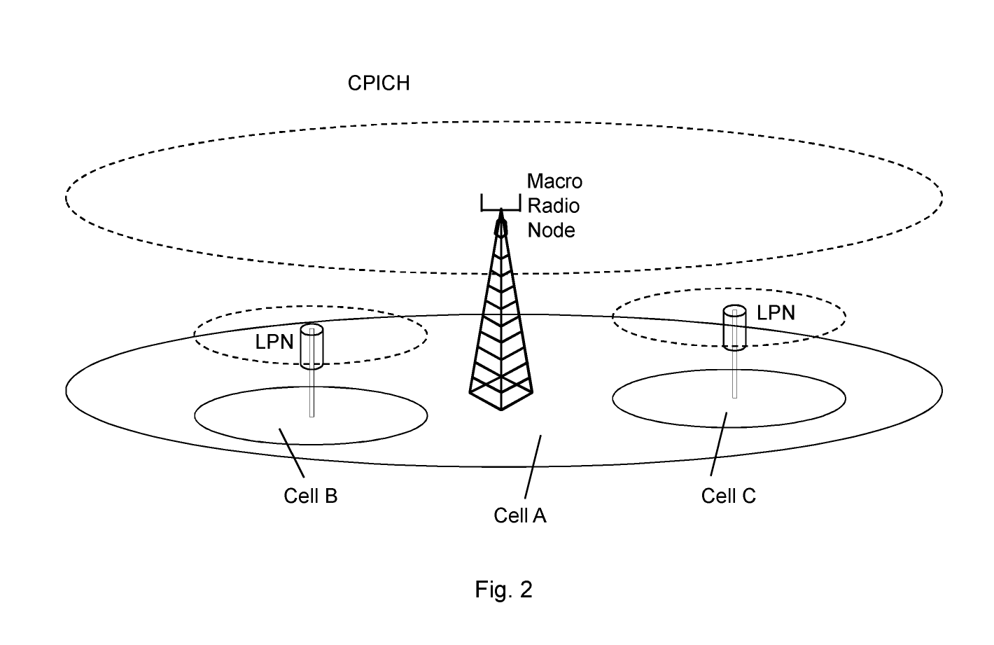

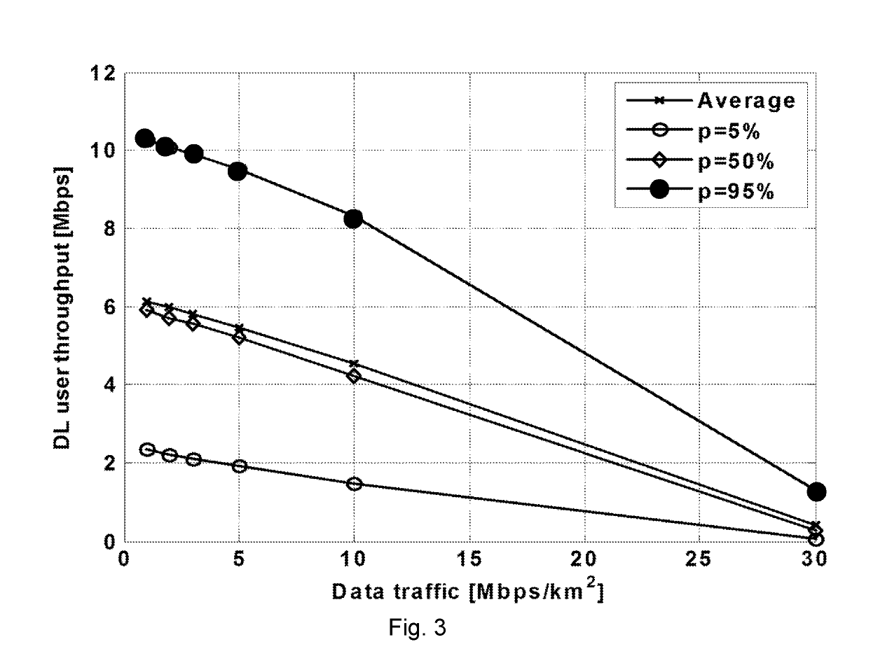

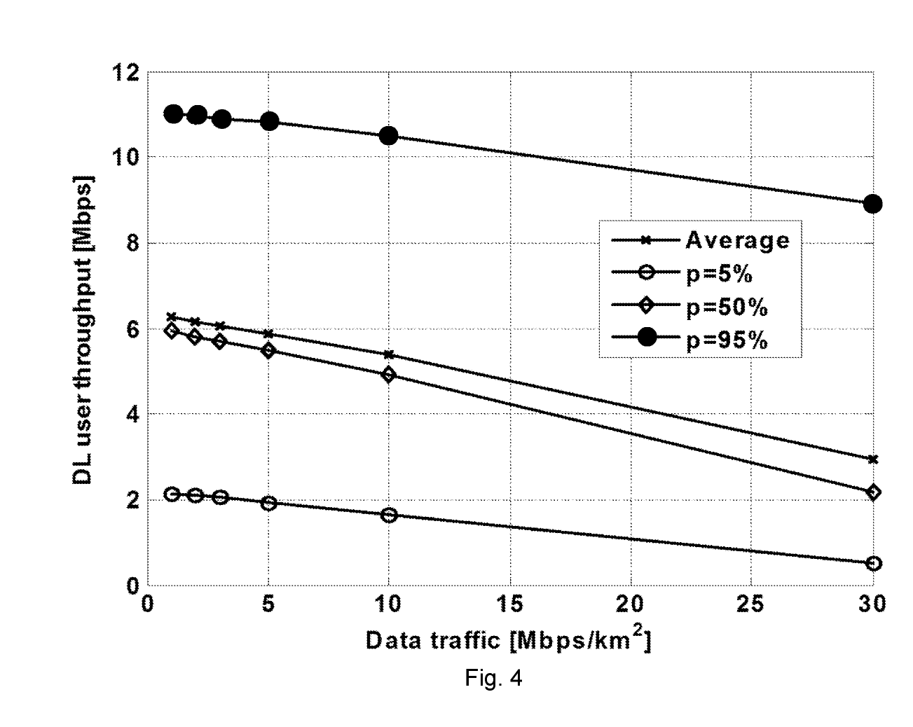

FIG. 2 illustrates an example of a heterogeneous network wherein a macro radio node creates a cell, Cell A, and where the low power nodes create different cells, Cell B and Cell C, which is an example of the co-channel deployment. Simulations indicate that significant gains in the system throughout as well as cell edge user throughput can be realized through the co-channel deployment. As an explanation, FIGS. 3 and 4 are presented below. Common Pilot Channel (CPICH) is used by the UEs to first complete identification of the Primary Scrambling Code used for scrambling Common Control Physical Channel (CCPCH) transmissions from the macro radio node.

FIG. 3 illustrates a graph of downlink user throughput, defined along a vertical axis, vs. data traffic, defined along a horizontal axis, in a homogeneous network. Note that data traffic is an indication of number of user equipments served and/or load. From FIG. 3, it can be observed that as the load, i.e. data traffic, increases in the homogeneous network deployment, the user throughput significantly decreases. One explanation is that in a homogeneous network, when there are many user equipments, each user equipment will receive fewer resources. Also user equipments with low Signal to Interference plus Noise Ratio (SINR), e.g. user equipments at a cell edge, may receive very little or even no resources. A line marked with black circles relates to a percentile of 95% of throughput, a line marked with transparent rhombs relates to a percentile of 50% of throughput. A line marked with transparent circles relates to a percentile of 5% of throughput. A line marked with arrows relates to an average throughput.

FIG. 4 also illustrates a graph of downlink user throughput, defined along a vertical axis, vs. data traffic, defined along a horizontal axis, but in a heterogeneous network co-channel deployment setting. From the FIG. 4, it can also be observed that as the load increases in the heterogeneous network co-channel deployment, the user throughput decreases. However, the user throughput drop off is much less severe, the gradient is smaller than in FIG. 3. This indicates that relative to the homogeneous network deployment, throughput gains can be realized through the co-channel deployment. The gains become more significant as the load e.g., data traffic increases. A line marked with black circles relates to a percentile of 95% of throughput, a line marked with transparent rhombs relates to a percentile of 50% of throughput. A line marked with transparent circles relates to a percentile of 5% of throughput. A line marked with arrows relates to an average throughput.

One reason for the improved throughput is that the co-channel deployment provides opportunities for load balancing. In a heavy data traffic scenario, the load in the macro cell may be shared between the macro node and low power nodes. Also user equipments with low SINR may be served by strategically located LPNs. In short, the LPNs may provide resources to serve user equipments and thereby increase average user throughput of the wireless communications network.

### Soft Cell Deployment

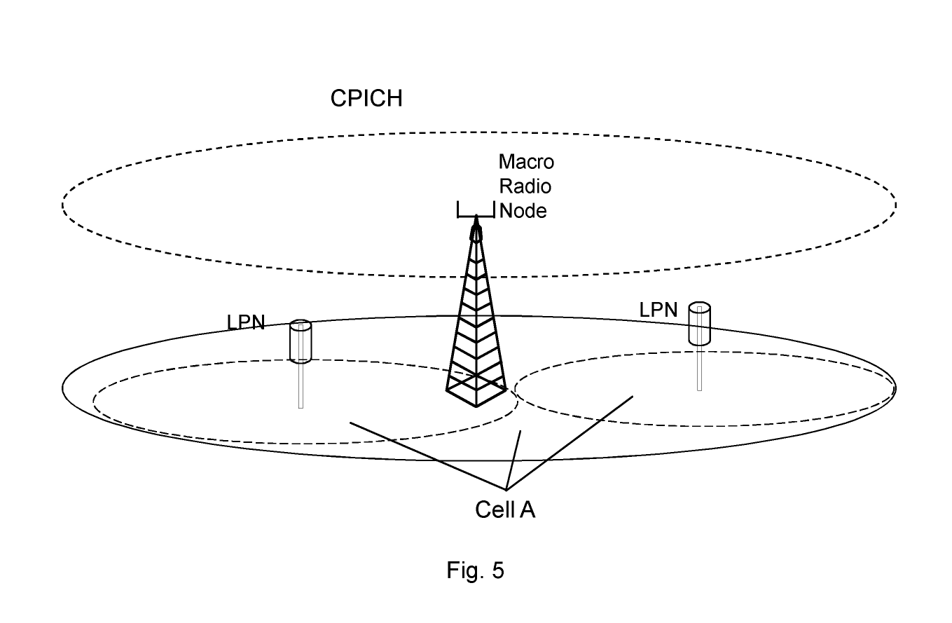

FIG. 5 illustrates a heterogeneous network with a soft cell, or combined cell, deployment. As indicated, the LPNs are part of the macro cell in this deployment. That is the macro radio node and the LPNs has the same cell ID, Cell A.

In one aspect, the soft cell deployment may be viewed as an example of a distributed Multiple Input Multiple Output (MIMO). Hence, the soft cell deployment may be used for different applications. For example, some number, e.g., half, of the transmitting antennas, or antenna branches, may be set up at the macro node, while the remainder, e.g., half, of the antennas, or antenna branches, may be installed at the LPNs. In this way, a distributed MIMO system may be implemented. Such set up may also avoid frequent soft handovers, hence higher layer signaling.

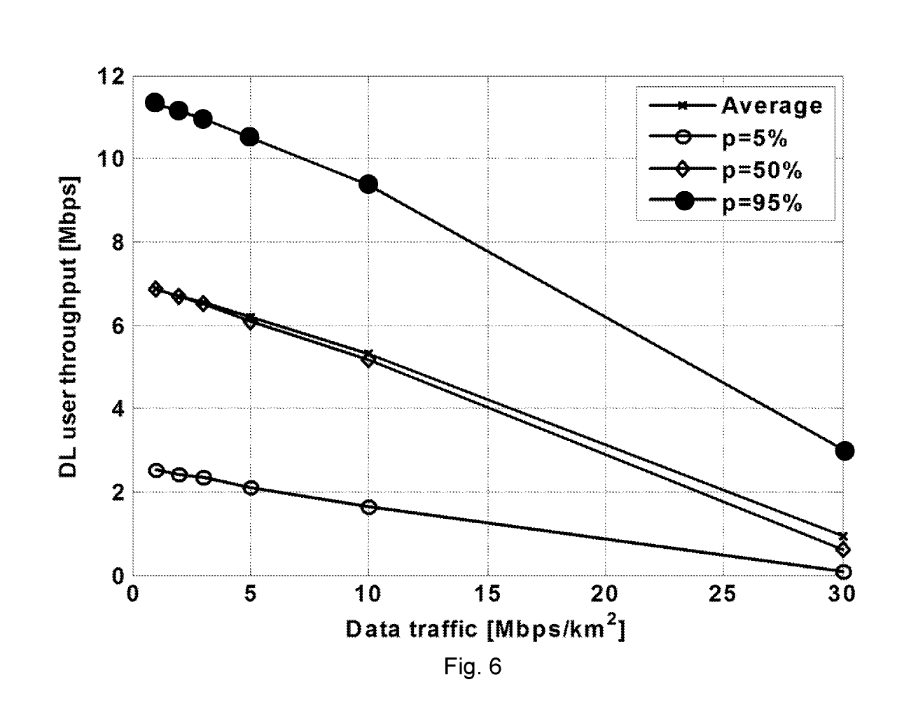

FIG. 6 illustrates a system simulation result in a heterogeneous network with the soft cell deployment. FIG. 6 illustrates a graph of downlink user throughput, defined along a vertical axis, vs. data traffic, defined along a horizontal axis. It can be observed when the load is low, the soft cell deployment may provide gains as all the LPNs can transmit to the same user equipment. In other words, significant increases in the beamforming gain may be realized at low loads. However, when the load increases, the performance drop-off becomes rather severe. A line marked with black circles relates to a percentile of 95% of throughput, a line marked with transparent rhombs relates to a percentile of 50% of throughput. A line marked with transparent circles relates to a percentile of 5% of throughput. A line marked with arrows relates to an average throughput.

### Adaptive LPN Configuration

From the discussion above, it can be observed that neither the co-channel nor the soft cell deployment alone can provide gains in all conditions. Under low load (data traffic) conditions, the soft cell configuration may provide better average user throughput, and thus be preferred over the co-channel configuration. But under relatively high load conditions, the co-channel configuration may be preferred. These and other problems associated with conventional techniques are addressed in this disclosure.

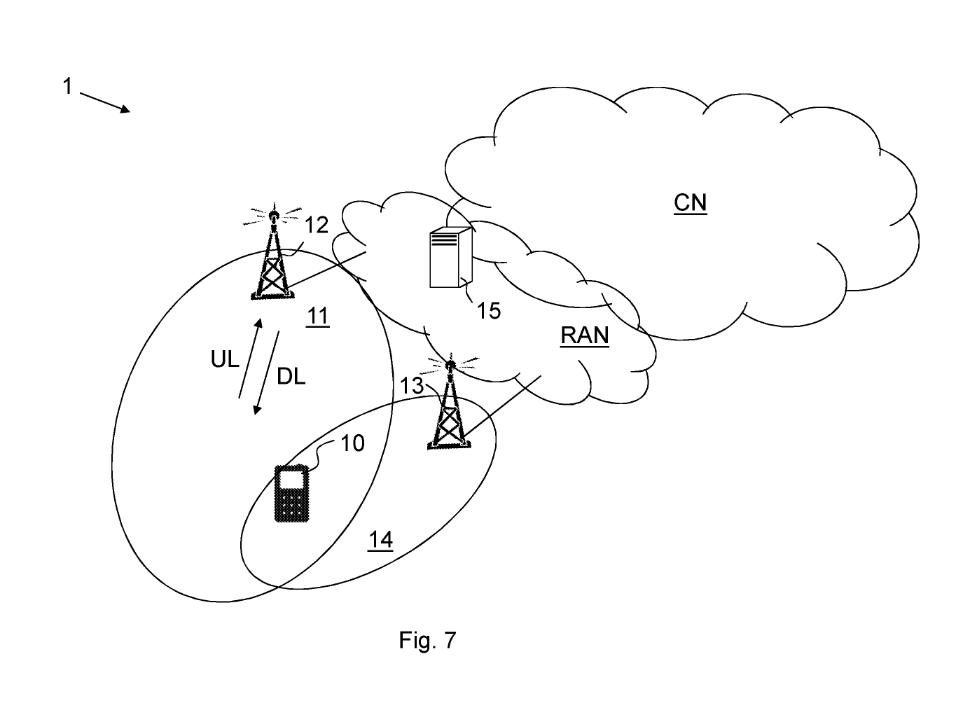

Embodiments herein relate to wireless communication networks in general. FIG. 7 is a schematic overview depicting a wireless communication network 1. The wireless communication network 1 comprises one or more RANs and one or more CNs. The wireless communication network 1 may use a number of different technologies, such as Long Term Evolution (LTE), LTE-Advanced, Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few possible implementations. The wireless communication network 1 is exemplified herein as a WCDMA network.

In the wireless communication network 1, a user equipment 10, also known as a mobile station, a wireless device and/or a wireless terminal, communicates via a Radio Access Network (RAN) to one or more core networks (CN). It should be understood by the skilled in the art that “user equipment” is a non-limiting term which means any wireless terminal, Machine Type Communication (MTC) device, a Device to Device (D2D) terminal, or node e.g. smartphone, laptop, mobile, sensor, relay, mobile tablets or even a small base station communicating within respective cell.

The wireless communication network 1 covers a geographical area which is divided into cell areas, e.g. a macro cell 11 being served by a radio base station e.g. a macro radio node 12. The macro radio node 12 is a network node and may also be referred to as a first radio base station and e.g. a NodeB, an evolved Node B (eNB, eNode B), a base transceiver station, Access Point Base Station, base station router, or any other network unit capable of communicating with a user equipment within the cell served by the radio base station depending e.g. on the radio access technology and terminology used. The macro radio node 12 may serve one or more cells, such as the macro cell 11.

A cell is a geographical area where radio coverage is provided by radio base station equipment at a base station site or at remote locations in Remote Radio Units (RRU). The cell definition may also incorporate frequency bands and radio access technology used for transmissions, which means that two different cells may cover the same geographical area but using different frequency bands. Each cell is identified by an identity within the local radio area, which is broadcast in the cell. Another identity identifying the macro cell 11 uniquely in the whole wireless communication network 1 is also broadcasted in the macro cell 11. The macro radio node 12 communicates over the air or radio interface operating on radio frequencies with the user equipment 10 within range of the macro radio node 12. The user equipment 10 transmits data over the radiointerface to the macro radio node 12 in Uplink (UL) transmissions and the macro radio node 12 transmits data over an air or radio interface to the user equipment 10 in Downlink (DL) transmissions.

Furthermore, the wireless communication network 1 comprises a second radio base station such as a low power node 13. The low power node 13 provides radio coverage over a second cell, e.g. a low power cell 14. The low power node 13 provides the low power cell 14 all or partially covered by the macro cell 11.

Furthermore, the radio communications network 1 comprises a Radio Network Controller (RNC) 15 configured to control the macro radio node 12 and the low power node 13.

For example, in one or more non-limiting aspects, one or more low power nodes, such as the low power node 13, of a heterogeneous network may be adaptively configured. A heterogeneous network may include one or more macro radio nodes, e.g. the macro radio node 12, and one or more low power nodes, e.g. the low power node 13, to provide wireless services to one or more wireless terminals, e.g. the user equipment 10. Each macro radio node, or simply macro node, may be a base station, e.g., eNB, Node B, eNode B, etc., structured to wirelessly communicate with one or more wireless terminals, e.g., UE, PDA, smart phone, etc. The macro radio node 12 may provide services to wireless terminals in a coverage area. For ease of reference, the coverage area of the macro radio node 12 will be referred to as the macro cell 11, and each macro cell may be individually identified through a cell id. Note that the same physical macro node 12 may serve multiple coverage areas, i.e., serve multiple macro cells. In this instance, the same physical macro node 12 may be viewed logically as multiple macro nodes with each macro node being associated with a macro cell identifiable through its cell id.

Each LPN, e.g., pico/femto/relay station such as the low power node 13, also has a corresponding coverage area where it can provide services to one or more wireless terminals that are within the coverage area. For ease of reference, the coverage area of the LPN will be referred to as a low power (LP) coverage area. The LP coverage area may be partially or completely overlapped by a macro cell corresponding to at least one macro node. In the co-channel deployment, the LP coverage area may be referred to as the low power (LP) cell 14, as stated above, that is identifiable through a cell id different from the cell id of the overlapping macro cell 11. In the soft cell deployment, the LP cell 14 takes on the cell id of the overlapping macro cell 11.

From one perspective, note that whether a node is designated as a macro radio node or a low power node need not be absolute. The node may be a macro radio node in one circumstance, and the same node may be a low power node in another circumstance. Between any two nodes whose corresponding coverage areas overlap, the node with the larger coverage area may be viewed as the macro node and the node with the smaller coverage area may be viewed as the low power node.

In one or more non-limiting aspects, a network node, such as the macro radio node 12 or the RNC 15, may adaptively configure one or more LPNs, such as the low power node 13, of the wireless communications network 1. For simplicity of description, an example scenario involving one LPN and one macro node will be described. However, the scope of the disclosed subject matter encompasses scenarios that involve any combination of one or many macro nodes each overlapping one or many LPNs.

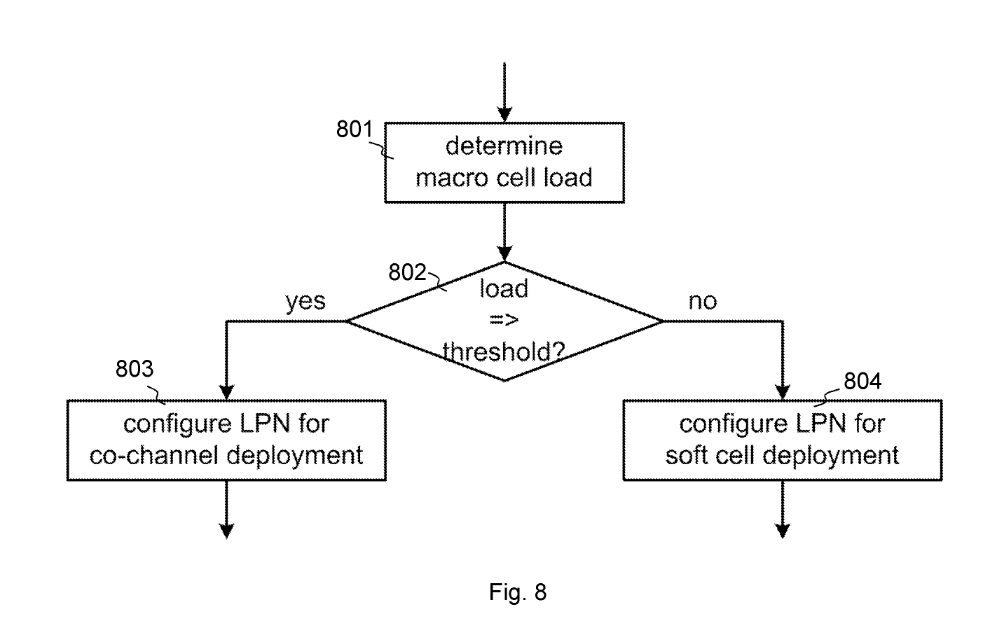

The network node may configure the LPN 13 based on a load, or load related factors, of the macro cell 11. A flow chart of a non-limiting example method performed by the network node is illustrated in FIG. 8. As illustrated in FIG. 8, the network node may:
Action 801. Determine the macro cell load, e.g., the load of the macro radio node 12 serving the macro cell 11;
Action 802. Compare the load to a threshold;
Action 803. Configure, i.e., activate, the LPN 13 as a co-channel deployment when the comparison indicates that the load on the macro cell 11 is relatively high, i.e. load greater than or equal to the threshold; and
Action 804. Configure the LPN 13 as a soft cell deployment when the comparison indicates that the load on the macro cell is relatively low, i.e. load less than the threshold.

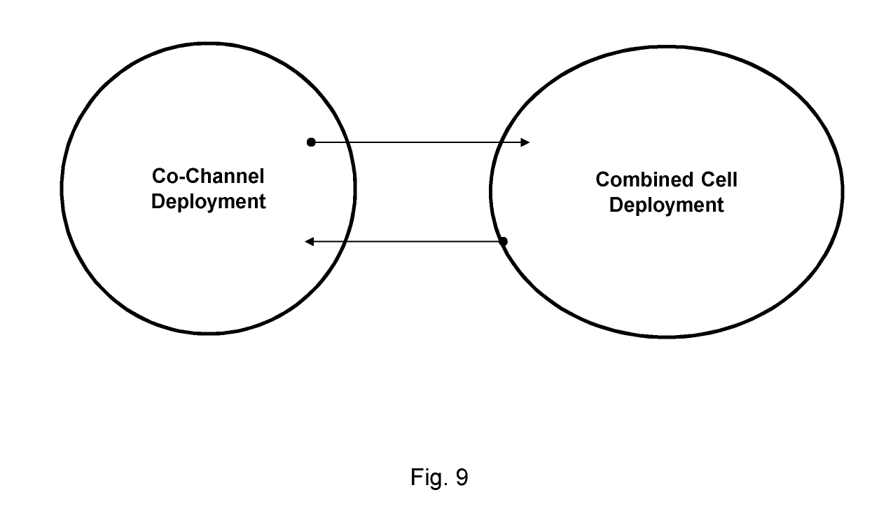

This process may be repeated for the same LPN 13 such that the LPN's deployment configuration may be changed, adapted, over time as the circumstances dictate. This is illustrated in FIG. 9 disclosing with the arrows that the configuration of the LPN 13 changes from co-channel deployment to soft cell deployment adaptively and repeatedly based on the changes of load in the macro cell 11.

The method may also be applied to other LPNs of the macro cell 11, as well as to LPNs of other macro cells. Generally, the method illustrated in FIG. 8 may be performed for some or all LPNs. Between any two LPNs, the same network node may perform the method for both LPNs, or two different network nodes may perform the method. While not strictly required, if the same macro cell 11 overlaps the LP coverage areas of both LPNs, it may be preferred that the same network node perform the method for both LPNs. For at least one LPN, the method may be repeated two or more times. Between any two repetitions of the method for that LPN, the same network node may perform the method both times, or two different network nodes may perform the method, one for each time.

In one embodiment, the macro cell load may be determined based on one or more load factors. One example of the load factor is a number active user equipments in the macro cell 11. Another load factor example is a Transmission Time Interval (TTI) utilization. Other examples include Transmit Format Combination Indicator (TFCI) and Enhanced TFCI. These simply serve as illustrations and should not be taken in a limiting sense.

An example technique for determining the load, as stated in Action 801, is as follows. The network node, such as the RNC 15 or the macro radio node 12, may check, periodically or a periodically, to determine a number of primary HSPA user equipments, denoted N_h, user equipments who have this cell as the serving High Speed Downlink Shared Channel (HS-DSCH) radio link. The RNC 15 may include a cell resource manager which contains information about the number of HSPA user equipments active in the macro cell 11. In another example, the macro radio node 12 (e.g., Node B) may inform a macro node, e.g., RNC 15, regarding the TTI utilization, periodically or a periodically.

In the above example techniques, the load is determined based on a single load factor—N_h or TTI utilization. Alternatively, the load may be determined based on multiple load factors. For example, the network node may determine the load based on a weighted combination of load factors such as N_h, TTI utilization, TFCI, E-TFCI among others. Further, the load may be determined based on the load factors observed over a window of time. For example, an average of the number of primary HSPA user equipments N_h over last 10 TTIs may be used as the load. Again, the techniques to determine the load as described above are merely examples and should not be taken to be limiting.

When the network node configures the LPN 13 for a co-channel deployment, the network node may configure the LPN 13 with a cell id, e.g., scrambling code, Physical Cell Identity (PCI), cell global identity (CGI), different from the macro cell 11. For example, the LPN 13 may be configured with a different scrambling code. Conversely, when the network node configures the LPN 13 for a soft cell deployment, the network node may configure the LPN 13 with a same cell id of the macro cell 11.

### Adaptive LPN Configuration

The methods to adaptively configure LPNs in a heterogeneous network may be performed by one or more network nodes. The network node can be a core network (CN) node, the radio network controller (RNC) 15, or even the macro radio node 12 itself. These are merely examples of network nodes and should be not taken in a limiting sense. Note that one macro radio node may configure a LPN that corresponds to a different macro radio node, e.g., primary serving node configuring for secondary serving nodes.

Since the combined cell deployment needs additional pilots only Release-12 UEs can get these gains. The pre Release-12 UEs, we call them as legacy UE, can't get spatial reuse gains with combined cell deployment. For supporting legacy UEs, the combined cell needs to be operated in Single Frequency Network (SFN) mode. Unfortunately the gains achieved with SFN mode are very low. E.g. the data transmission from two nodes in SFN mode to a Release-12 UE when the load is low from the other node and the UE is in between Node 1 and Node-2. In this case, it benefits from simultaneous data transmission from two nodes, hence the SINR is boosted. Also note that the two links may use same scrambling code, either it can be same primary scrambling code of serving cell on e.g. Primary Control Pilot Channel (P-CPICH) or the secondary or a common scrambling code. The UE 10 may apply pilot cancellation from cells that are transmitting pilots with a different scrambling code to HS-PDSCH in order to further improve the performance.

Since the pilots are different for each node, handover may be initiated when the user equipment serving cell quality is below the neighbour cell quality. In these cases, the benefits of combined cell can be lost. Hence the RNC 15 may configure the UE 10 not to initiate a handover when the signal quality of certain neighbours is better than the serving cell. Or it can configure the UE 10 to add signal qualities from certain cells when doing the handover decisions. For example, the UE 10 may be instructed that certain cells belong to a “co-operating set”. Belonging to a co-operating set would imply that (i) The UE 10 should receive probing pilots from each of the cells and (ii) When making Radio Resource Managing (RRM) measurements on P-CPICH, the P-CPICH RSCP from each of the cells in the set should be combined, and P-CPICH Ec/lo should be calculated on the basis of the combination of power from each of the cells

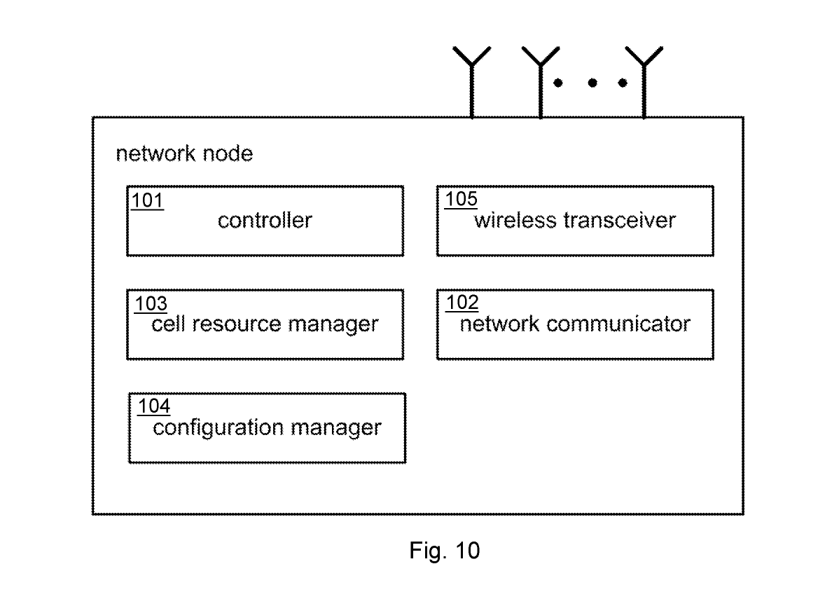

FIG. 10 illustrates an example embodiment of a network node which may include a controller 101, a network communicator 102, a cell resource manager 103, and a configuration manager 104. If the network node is a macro radio node, the network node may also include a wireless transceiver 105.

The wireless transceiver 105 may be structured to perform radio communications with wireless terminals, i.e. user equipments, via one or more antennas. The network communicator 102 may be structured to perform wired and/or wireless communication with other network nodes. The cell resource manager 103 may be structured to monitor and/or keep track of information related to the load at the macro cell 11. The configuration manager 104 may be structured to adaptively configure the low power node 13 based on the macro cell load. The controller 101 may be structured to control the overall operation of the network node.

FIG. 10 provides a logical view of the network node and the components included therein. It is not strictly necessary that each component be implemented as physically separate modules. Some or all components may be combined in a physical module.

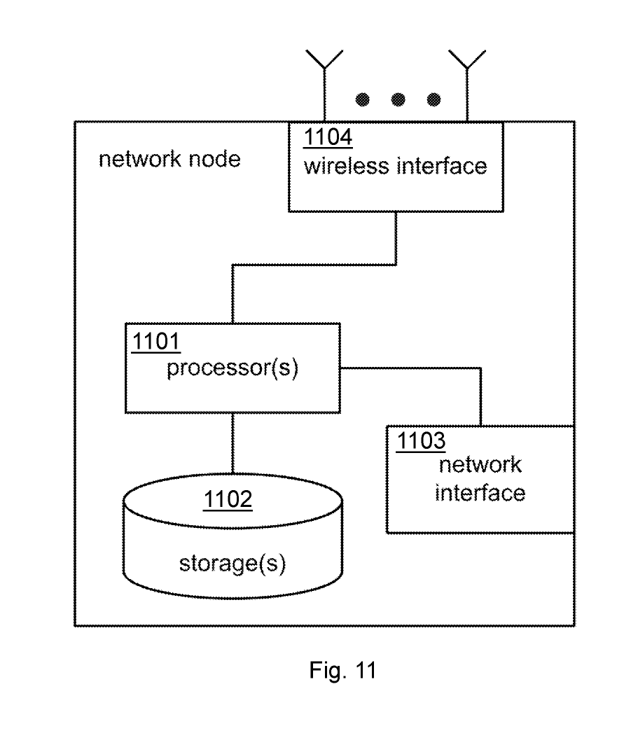

Also, the components of the network node need not be implemented strictly in hardware. It is envisioned that the components can be implemented through any combination of hardware and software. For example, as illustrated in FIG. 11, the network node may include one or more hardware processors 1101, one or more storages 1102 (internal, external, both), and one or both of a wireless interface 1103 (in case of a macro radio node) and a network interface 1104.

The processor(s) 111 may be configured to execute program instructions to perform the functions of one or more of the network node components. The instructions may be stored in a non-transitory storage medium or in firmware (e.g., ROM, RAM, Flash) (denoted as storage(s)). Note that the program instructions may also be received through wired and/or or wireless transitory medium via one or both of the wireless and network interfaces. The wireless interface 113 (e.g., a transceiver) may be configured to receive signals from and send signals to wireless terminals via one or more antennas. The network interface 114 may be included and configured to communicate with other network nodes.

Some or all aspects of the disclosed subject matter may be applicable in a heterogeneous network comprising one or more macro radio nodes and one or more low power nodes. Each macro radio node may provide services within a coverage area (a macro cell) corresponding to that macro radio node. The macro cell may be identifiable, e.g., by a cell id. Each low power node may provide services within a coverage area (a low power coverage area) corresponding to that low power node.

An aspect of the disclosed subject matter may be directed to a method in a heterogeneous network to adaptively configure a low power node whose corresponding low power coverage area is partially or completely overlapped by a macro cell corresponding to a macro radio node, wherein the method may comprise:
Determining a macro cell load on the macro cell;
Determining whether the macro cell load is greater than or equal to a macro cell load threshold;
Configuring the low power node for a co-channel deployment when it is determined that the macro load is greater than or equal to the macro cell load threshold; and
Configuring the low power node for a soft cell deployment when it is determined that the macro load is not greater than or equal to the macro cell load threshold.

A network node of the heterogeneous network may perform the method. The method may be performed for some or all low power nodes. Between any two low power nodes, the same network node may perform the method for both low power nodes, or by different network nodes. For at least one low power node, the method may be repeated over time. Between any two repetitions of the method for that low power node, the same network node may perform the method both times or different network nodes may perform the method each time.

Another aspect of the disclosed subject matter may be directed to a network node of a heterogeneous network structured to adaptively configure a low power node whose corresponding low power coverage area is partially or completely overlapped by a macro cell corresponding to a macro radio node, wherein the network node may comprise a cell resource manager and a configuration manager, wherein
The cell resource manager is structured to:
   Determine a macro cell load on the macro cell; and
   Determine whether the macro cell load is greater than or equal to a macro cell load threshold; and
The configuration manager is structured to:
   Configure the low power node for a co-channel deployment when the cell resource manager determines that the macro load is greater than or equal to the macro cell load threshold; and
   Configure the low power node for a soft cell deployment when the cell resource manager determines that the macro load is not greater than or equal to the macro cell load threshold.

An aspect of the disclosed subject matter may be directed to program instructions which when executed by a computer of a network node, causes the network to perform the method as described above. The program instructions may be received through a transitory medium and executed directly therefrom. The program instructions may also be stored in a non-transitory storage medium and the network node may read the program instructions therefrom.

A non-exhaustive list of advantages of one or more aspects of the disclosed subject matter include:
Both beamforming and load balancing gains are achievable;
Energy from the LPN can be used efficiently for beamforming when the load is relatively small in a cell.

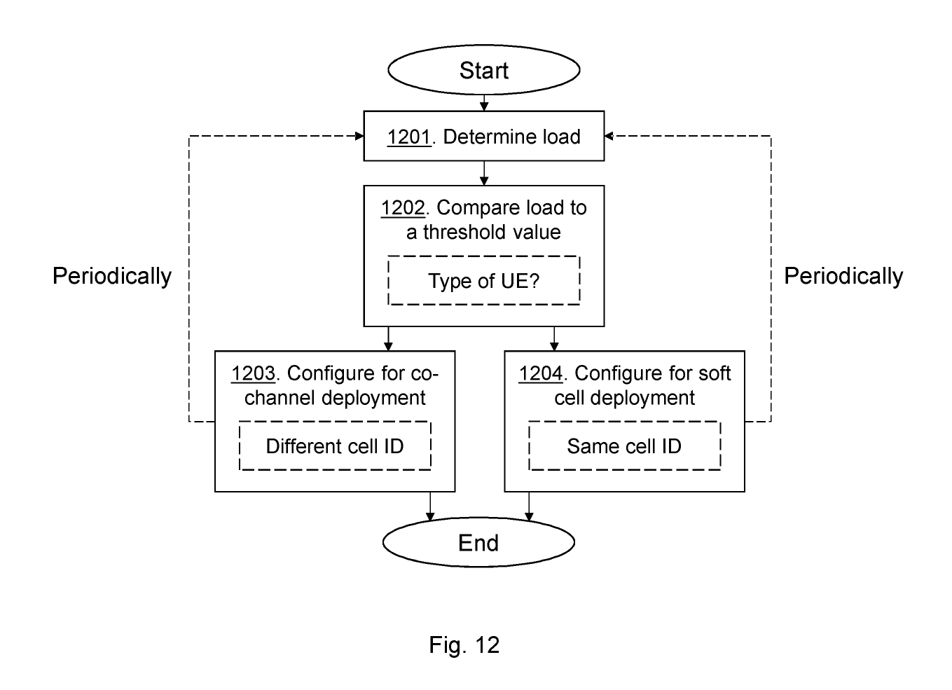

The method actions in the network node, such as the macro radio node 12 or the RNC 15, for configuring the low power node 13 in the wireless communications network 1 according to some embodiments will now be described with reference to a flowchart depicted in FIG. 12. The actions do not have to be taken in the order stated below, but may be taken in any suitable order. The wireless communications network 1 comprises the low power node 13 and a macro radio node 12, wherein the low power node 13 has a coverage area that is partially or completely overlapped by a coverage area of a cell of the macro radio node 12. The wireless communications network 1 may for example be a heterogeneous network.

Action 1201. The network node determines a load of the cell 11 of the macro radio node 12. The load may be determined based on number of active user equipments; TTI utilization, TFCI, Enhanced TFCI; and/or similar.

Action 1202. The network node compares the load with a threshold value.

Action 1203. The network node configures the low power node 13 for a co-channel deployment when the load is greater than or equal to the threshold value. For example, the network node configures the low power node 13 with a cell identity different from a cell identity of the cell of the macro radio node 12.

Action 1204. The network node configures the low power node 13 for a soft cell deployment when the load is not greater than or equal to the threshold value. For example, the network node the low power node 13 with a cell identity same as for the cell of the macro radio node 12.

In some embodiments also a type of a user equipment 10 (connected in one or both cells) is also taken into account when configuring the low power node 13. For example, if the user equipment 10 is of a type before release 12 standard co-channel deployment is preferred and used. And if the user equipment 10 is of a type according to standard release 12 or later also soft cell deployment may be used, hence, the network node may configure the low power node 13, based on load, for aco-channel deployment or a soft cell deployment when the user equipment 10 is of the type release 12 or later.

The method may be performed periodically and the low power node is configured adaptively.

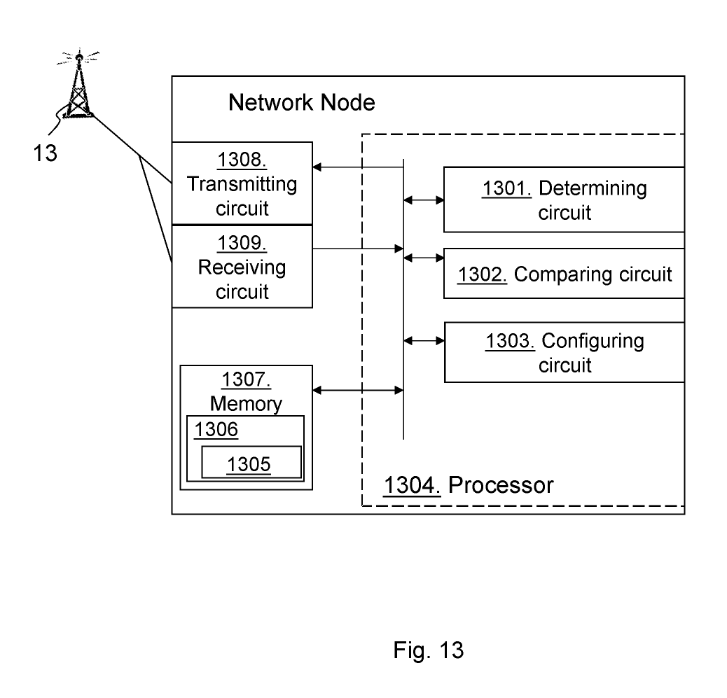

According to embodiments herein a network node for configuring one or more low power nodes in the wireless communications network 1 is herein provided, depicted in FIG. 13. The wireless communications network 1 comprises the low power node 13 and a macro radio node 12, wherein the low power node 13 has a coverage area that is partially or completely overlapped by a coverage area of a cell 11 of the macro radio node 12. The network node being configured to perform the method actions above. The wireless communications network 1 may be a heterogeneous network.

For example, the network node may comprise a determining circuit 1301 configured to determine a load of the cell 11 of the macro radio node 12. The determining circuit may be configured to determine the load based on number of active user equipments; TTI utilization, TFCI, Enhanced TFCI; and/or similar.

The network node may further comprise a comparing circuit 1302 configured to compare the load with a threshold value.

In addition, the network node may comprise a configuring circuit 1303 adapted to configure the low power node 13 for a co-channel deployment when the load is greater than or equal to the threshold value; and adapted to configure the low power node 13 for a soft cell deployment when the load is not greater than or equal to the threshold value.

For example, the configuring circuit 1303 may be adapted to configure the low power node for a co-channel deployment by configuring the low power node 13 with a cell identity different from a cell identity of the cell of the macro radio node 12; and/or to configure the low power node for a soft cell deployment by configuring the low power node 13 with a cell identity same as for the cell of the macro radio node 12. The configuring circuit 1303 may be configured to perform the configuring periodically to adaptively configure the low power node 13. The configuring circuit 1303 may further be configured to take type of the user equipment 10 into account when configuring the low power node 13.

The network node may be a radio network controller or the macro radio node 12. The embodiments herein for configuring the low power node 13 may be implemented through one or more processors 1304 in the network node depicted in FIG. 13, together with computer program code for performing the functions and/or method actions of the embodiments herein. The computer program code may also be provided as a computer program product 1305, for instance stored on a computer readable medium 1306, such as a carrier, carrying the computer program product 1305 for performing embodiments herein when being loaded into the network node. One such carrier may be in the form of a CD ROM disc. It is however feasible with other data carriers such as a memory stick. The computer program code may furthermore be provided as pure program code on a server and downloaded to the network node. Thus, embodiments herein disclose the computer program product 1305 comprising instructions, which, when executed on at least one processor in the network node, cause the at least one processor to carry out the method according to any of the embodiments disclosed herein. Furthermore, the computer-readable storage medium 1306 comprising the computer program product stored thereon is also disclosed herein.

The network node further comprises a memory 1307. The memory 1306 comprises one or more units to be used to store data on, such as load, threshold values, cell IDs, type of UE, applications to perform the methods disclosed herein when being executed, and similar. The network node comprises a transmitting circuit 1308 to be used e.g. when configuring the low power node 13 and a receiving circuit 1309 e.g. for communicating with the low power node 13.

As will be readily understood by those familiar with communications design, that functions from other circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless terminal or network node, for example.

Alternatively, several of the functional elements of the processing circuits discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications receivers will appreciate the cost, performance, and maintenance tradeoffs inherent in these design choices.

It will be appreciated that the foregoing description and the accompanying drawings represent non-limiting examples of the methods and apparatus taught herein. As such, the inventive apparatus and techniques taught herein are not limited by the foregoing description and accompanying drawings. Instead, the embodiments herein are limited only by the following claims and their legal equivalents.

### ABBREVIATIONS

E-TFCI Enhanced TFCI
HSDPA High Speed Downlink Packet Access
HSPA High Speed Packet Access
LPN Low Power Node
MIMO Multiple-Input Multiple-Out-put
TFCI Transmit Format Combination Indicator
TTI Transmit Time Interval

1. A method in a network node for configuring a low power node in a wireless communications network, which wireless communications network comprises the low power node and a macro radio node, wherein the low power node has a coverage area that is partially or completely overlapped by a coverage area of a cell of the macro radio node, the method comprising
determining a load of the cell of the macro radio node;
comparing the load with a threshold value;
configuring the low power node for a co-channel deployment when the load is greater than or equal to the threshold value; and
configuring the low power node for a soft cell deployment when the load is not greater than or equal to the threshold value threshold value.

2. A method according to claim 1, wherein configuring the low power node for a co-channel deployment comprises configuring the low power node with a cell identity different from a cell identity of the cell of the macro radio node; and/or wherein configuring the low power node for a soft cell deployment comprises configuring the low power node with a cell identity same as for the cell of the macro radio node.

3. A method according to claim 1; wherein the method is performed periodically and the low power node is configured adaptively.

4. A method according to claim 1; wherein the load is determined based on number of active user equipments; Transmission Time Interval, TTI, utilization, Transmit Format Combination Indicator, TFCI, Enhanced TFCI; and/or similar.

5. A method according to claim 1, wherein the wireless communications network is a heterogeneous network.

6. A method according to claim 1, wherein the network node is a radio network controller or the macro radio node.

7. A method according to claim 1, wherein type of the user equipment is also taken into account when configuring the low power node.

8. A network node for configuring a low power node in a wireless communications network, which wireless communications network comprises the low power node and a macro radio node, wherein the low power node has a coverage area that is partially or completely overlapped by a coverage area of a cell of the macro radio node, the network node being configured to:
determine a load of the cell of the macro radio node;
compare the load with a threshold value;
configure the low power node for a co-channel deployment when the load is greater than or equal to the threshold value; and
configure the low power node for a soft cell deployment when the load is not greater than or equal to the threshold value.

9. A network node according to claim 8, wherein the network node is configured to configure the low power node for a co-channel deployment by configuring the low power node with a cell identity different from a cell identity of the cell of the macro radio node; and/or to configure the low power node for a soft cell deployment by configuring the low power node with a cell identity same as for the cell of the macro radio node.

10. A network node according to claim 8, configured to perform the configuring periodically to adaptively configure the low power node.

11. A network node according claim 8, configured to determine the load based on number of active user equipments; Transmission Time Interval, TTI, utilization, Transmit Format Combination Indicator, TFCI, Enhanced TFCI; and/or similar.

12. A network node according to claim 8, wherein the wireless communications network is a heterogeneous network.

13. A network node according to claim 8, wherein the network node is a radio network controller or the macro radio node.

14. A network node according to claim 8, wherein the network node is further configured to take type of the user equipment into account when configuring the low power node.

15. (canceled)

16. (canceled)
